(19) United States
(12) Patent Application Publication
(10) Pub. No.: US 2024/0409245 A1
(43) Pub. Date: Dec. 12, 2024

(54) LOW ENERGY IMPACT KITCHEN SYSTEM, CONFIGURED FOR INSTALLATION IN A REMOTE AND HARSH OR EXTRA-TERRESTRIAL ENVIRONMENT

(71) Applicant: AZIONARIA COSTRUZIONI MACCHINE AUTOMATICHE A.C.M.A. S.P.A., Bologna (IT)

(72) Inventors: Ivanoe BERTUZZI, Bologna (IT); Luca CERATI, Bologna (IT); Enrico FEDERICI, Bologna (IT); Marco GHINI, Bologna (IT); Filippo HULLER, Bologna (IT); Giacomo IMBRIACO, Bologna (IT); Riccardo RUGGERI, Bologna (IT); Stefano SINIGARDI, Bologna (IT); Valentina SUMINI, Bologna (IT)

(21) Appl. No.: 18/699,850

(22) PCT Filed: Oct. 11, 2022
(86) PCT No.: PCT/IB2022/059730

§ 371 Date: Apr. 9, 2024

(30) Foreign Application Priority Data
Oct. 11, 2021 (IT) 102021000026021

(51) Int. Cl. B64G 99/00; A01G 31/00; A21C 11/00; A47J 36/24; A47J 36/32; A47J 43/044; A47J 43/07; A47J 44/00; A47J 47/01; B64G 1/60; H05B 3/02

(52) U.S. Cl. CPC B64G 99/00; A21C 11/00; A47J 36/2483; A47J 36/321; A47J 43/044; A47J 43/0711; A47J 44/00; A47J 47/01; B64G 1/60; H05B 3/02; A01G 31/00; A47J 2043/04472; A47J 2201/00

(57) ABSTRACT

A low energy impact kitchen system, for installation in a remote and harsh or extra-terrestrial environment and in particular in the absence of terrestrial ground and/or on space platforms, comprising a standing area, a working area around the standing area and, in the working area: a distribution unit, including containers or compartments to store and release individually in a controlled manner a plurality of predetermined doses of different raw or semi-processed materials; a multifunction unit for actuating functions of mixing, chopping and/or cooking by induction a raw or semi-processed material or a mixture of raw or semi-processed materials; and further operating units for thermal treatment of products or semi-processed products and/or for auxiliary operations, and/or for processing semi-processed food products. The system comprises an area for the growing of plants, in particular fruit and/or vegetables, operating in the absence of soil, in particular a hydroponic, aquaponic, aeroponic cultivation.

### TECHNICAL FIELD

This invention relates to a kitchen system with reduced energy impact configured for installation in a remote and harsh or extra-terrestrial environment and in particular in the absence of terrestrial ground and/or on spatial platforms. The term “harsh environment” means an environment with difficult access to the natural resources such as, for example, places close to glaciers or the North or South Poles or offshore platforms.

### BACKGROUND ART

It is known that in remote and harsh environments or in the absence of terrestrial ground, for example on space ships or in extra-terrestrial environments, the lack of a direct supply of raw materials and electricity supply as well as the availability of extremely limited space does not allow the installation of traditional kitchen systems.

There is therefore the need to have an efficient kitchen system which can be installed in environments where it is not possible to have a traditional kitchen or a kitchen with sufficient functionality.

### Aim of the Invention

The aim of the invention is to provide a kitchen system which has very small installation dimensions.

Another aim of the invention is to provide a kitchen system which has a low energy consumption or in any case optimised for applications in which there is no unlimited available power.

The aims specified are substantially achieved by a kitchen system comprising the technical features described in one or more of the appended claims 1 to 12.

In particular, the kitchen system according to the invention comprises a standing area for a user, that is to say, a treadable surface or an area which can be occupied by a user during use of the kitchen system. The standing area may be defined, in the case of installation in areas with a force of gravity, by a portion of floor.

Preferably, the kitchen system also comprises a working area positioned around the standing area. This working area is defined, for example, by a work surface raised with respect to the floor. The work surface may have any shape, preferably having an “L” or “C” shape in plan view.

Preferably, the kitchen system also comprises, positioned in the working area, operating units powered by electricity, in particular which can be used for operations directly connected with the preparation of food and/or auxiliary units. In particular, said operating units are designed for the thermal treatment of products or semi-processed products and/or designed for auxiliary operations, for example washing, and/or designed for processing semi-processed food products.

These operating units comprise at least one between:
a distribution unit, intended for the controlled distribution of ingredients or semi-finished products;
a multifunction unit configured to carry out operations on ingredients or semi-finished products;
a pasta making device configured for the automatic preparation of pasta or filled pasta;
at least one ohmic heating device actuated on containers, in particular closed thermoses, containing a semi-finished product or a product to be heated and/or sterilized;
at least one pressing unit configured for pressing or grinding raw materials;
at least one dishwasher;
at least one refrigerator.

Preferably, the kitchen system also comprises a sink 80, in particular positioned at the level of the work surface.

Preferably, the kitchen system also comprises an area for the growing of plants, in particular fruit and/or vegetables, operating in the absence of soil, in particular a hydroponic, aquaponic and/or aeroponic cultivation. According to the use of this growing area, there is the significant advantage that the use of washing water is not strictly required, with consequent water saving.

The growing area is positioned outside the standing and working area, therefore separate from the kitchen environment but preferably positioned in the immediate vicinity, for example in an adjacent room.

According to an aspect of the invention, the distribution unit is configured to store and release individually in a controlled manner a plurality of predetermined doses of different raw or semi-processed materials.

Preferably, the distribution unit comprises a plurality of columns placed side by side extending at least partly vertical and each defining a plurality of compartments in a stacked configuration.

Preferably, each column has release means, with manual or automatic action, for releasing a single dose. In particular, the release means are associated with each container or compartment of each column in such a way that each container or compartment has respective release means with independent operation.

More preferably, each column is defined by a channel defining compartments superposed on each other and communicating, separated by walls which can be opened manually or in a controlled manner in such a way that adjacent compartments are separated from each other by said walls which can be opened. Similarly, the lower compartment of each column is also equipped below with a wall which can be opened manually or in a controlled fashion. Below each column there is a space, between the column and the work surface, for resting a collection container.

Therefore, by opening a wall which can be opened, the contents of a compartment are discharged into the compartment below, or into the collection container in the case of the lower compartment.

Preferably, each compartment is associated with a respective weighing scale, in particular of the type with a load cell. The weighing scale may be preferably associated with the respective wall of the compartment which can be opened.

According to an aspect of the invention, the multifunction unit is configured for actuating functions of mixing and/or chopping and/or cooking by induction a raw or semi-processed material or a mixture of raw or semi-processed materials. These operations can be performed separately or simultaneously.

Preferably, the multifunction unit comprises one or more operating stations which are independent of each other and in particular identical.

Preferably, each operating station comprises a lower plate for induction heating, in particular mounted on the work surface.

Preferably, each operating station comprises an upper hood which can be lifted and lowered towards and away from an underlying container, in particular a container (plate) positioned on the induction plate. The lowered position allows an effective heating and a complete removal of the cooking fumes, which do not reach the environment. Preferably, the fumes can be collected and processed using a suitable treatment device.

Preferably, the hood is equipped with mixing and/or chopping means for operating in a container positioned between the lower plate and the upper hood.

According to an embodiment, the mixing and/or chopping means comprise a rotary element, preferably equipped with blades, positioned inside the hood and facing downwards.

Preferably, the rotary unit can be lifted and lowered with respect to the hood, therefore independently of the hood, to adopt a position below protruding from the hood in such a way as to be inserted into the container, and a position completely retracted in the hood to allow a safe operation by an operator in the positioning or removal of the container.

Preferably, each hood includes an upper heating counter-plate configured to face the container positioned between the lower plate in an operating configuration, for example for cooking food with a flat shape which can be heated on both sides (flat breads or the like). The upper counter-plate is preferably fixed with respect to the hood.

Preferably, the multifunction unit comprises a plurality of operating stations aligned along a direction of extension of the working area around the standing area, in particular along the work surface.

According to an aspect of the invention, the pasta making device comprises upper openings for receiving flour, water and filling and a compartment or lower door for dispensing one or more portions of pasta. This allows a fully automatic operation of the pasta making device except for the loading of the ingredients.

According to an aspect of the invention, each ohmic heating device comprises a receiving seat equipped with a front opening for inserting a respective container to be heated. By means of electrical contacts positioned inside the receiving body and configured to come into contact with the container during insertion, an automatic heating of the container can be obtained which can be activated directly by inserting the container in the front opening.

This heating may be performed for sterilising the contents of the container or for a heating aimed at immediate consumption of the contents, therefore alternatively to the induction heating by the multifunction unit.

In accordance with an aspect of the invention, the pressing unit is configured for pressing cereals and seeds and obtaining, respectively, flour and oil. For this purpose, the pressing unit may be equipped with means for grinding and/or flattening and collecting the material obtained.

According to an embodiment, above the work surface there are the distribution unit, the multifunction unit and the pasta making device. Moreover, below the work surface there can be a housing for a refrigerator and dishwashers, the ohmic heating devices and the pressing unit.

Preferably, at least some of the operating units are configured in a modular fashion in such a way as to be able to add or remove modules, obtaining a desired number of modules. For example, the multifunction unit may comprise a plurality of independent operating stations distributed on the work surface or the pressing unit and/or the ohmic heating devices may comprise a succession of adjacent modules, in particular integrated in a single compartment and individually accessible and/or operable.

According to another aspect of the invention, the operating units are configured to operate automatically, preferably in a fully automatic manner, apart from an activation controlled by the user.

According to another aspect of the invention, the kitchen system also comprises an electronic control unit connected to the operating units to receive information relating to operating parameters of some of said units or all of said units. Preferably, the electronic control unit is connected to the operating units to receive information relating to at least one energy absorption parameter from the operating units.

According to an embodiment, but not necessarily, the electronic control unit is also configured to determine and/or set up operating conditions of said operating units. This is achieved, for example, by allowing the electronic control unit to directly activate or control said units, preferably to enable or disable the operation of each of said units. In effect, in this solution, the electronic control unit may intervene to prevent exceeding the total power absorption, keeping it below a predetermined threshold.

According to an embodiment, the electronic control unit is configured to provide an indication of exceeding a limit value of absorbed electrical power, for example an audio and/or luminous signal, indicating to the user that the activation of an operating unit can lead to or is leading to the exceeding of the power threshold, thus signalling the need to stop the operating unit (or in any case intervene manually to return the absorption within the allowed range). In the latter circumstance, the electronic control unit may be configured to simulate the energy absorption level planned for an operating cycle of the operating units and to prevent activation of one or more operating units depending on the overall energy absorption level planned.

According to a different embodiment, the electronic control unit intervenes directly by disabling one or more operating units. For example, the electronic control unit may include a predetermined algorithm set to enable the operation of some of said units and to disable the operation of the other units whilst maintaining the overall power absorption below the predetermined threshold.

Preferably, the electronic control unit is also connected to the area for growing plants for collecting information regarding the progress of the growth of the plants.

Preferably, this information regarding the progress of growth of the plants is obtained by analysing images collected by one or more video cameras, in particular using an automatic system based on artificial intelligence.

Preferably, the electronic control unit comprises a plurality of pre-stored menus (stored by the manufacturer or by a user) or pre-set menus (that is to say, pre-selected from a list of menus) and which can be selected by an operator and/or selected automatically as a function of at least one selection parameter.

Preferably, the at least one selection parameter comprises a preset personalised diet. Such personalised diets can be defined, for example, according to one or more characteristics of the individual user, in particular age, weight, gender, nutritional needs, medical history.

In addition or alternatively, the at least one selection parameter is an information relating to ingredients available, in particular the ingredients stored in the distribution unit.

Preferably, each menu comprises a sequence of automatic operations which can be performed by the operating units and which can be activated automatically and/or manually.

Alternatively or in addition, each menu may comprise a sequence of operations to be performed manually by a user.

Preferably the electronic control unit can be operated by a user by means of a touch screen input terminal, in particular a smartphone, a tablet or a control panel.

Preferably, the electronic control unit is configured to generate instruction by generating audio-visual information in the augmented reality environment.

Preferably, the electronic control unit is configured to generate an instruction, in particular visual or audio, regarding a method for storing different types of products inside the distribution unit.

Preferably, this information regarding the methods of storage of different types of products inside the distribution unit represents one of the items of audio-visual information generated in the augmented reality environment.

Preferably, the electronic control unit is connected or connectable to sensors worn by a group of kitchen users (for example, a work team) for collecting personal health data of the users.

The invention also relates to a kitchen process comprising the technical features described in one or more of the appended claims from 13 to 18.

In particular, the cooking process according to the invention comprises a step of implementing a cultivation of plants, in particular fruit and/or vegetables, in the absence of terrestrial soil. Preferably, this cultivation is a hydroponic, aquaponic and/or aeroponic cultivation.

Preferably, the process comprises a step of storing predosed quantities of a raw material or semi-finished product picking up a predosed quantity of a raw material or semi-finished product in a distribution unit comprising a plurality of containers or compartments and configured for storing and releasing individually in a controlled manner said predosed quantities.

Preferably, the step of storing predosed quantities of a raw material or semi-finished product in the distribution unit is carried out by collecting the plants from said cultivation of plants and storing the plants in the distribution unit.

Preferably, the distribution unit comprises a plurality of columns placed side by side extending at least partly vertical and each defining a plurality of compartments or containers in a stacked configuration.

Preferably, each column has release means, with manual or automatic action, for releasing a single dose from each compartment or container.

Preferably, vertically adjacent compartments are separated from each other by a wall which can be opened in a controlled manner for discharging a dose in the compartment below. Preferably, the lower compartments are also equipped with a discharge wall which can be opened in a controlled manner.

Preferably, the step of storing predetermined quantities of a raw material (plants) or semi-finished products in the distribution unit is performed by storing, for each column, a plurality of same raw materials or semi-finished products, in such a way that each column of the distribution unit contains a same type of content.

Preferably, the process comprises a step of picking up a predetermined quantity of a raw material or semi-finished product from the distribution unit.

Preferably, the picking up step is performed by picking up individual portions of said plants from the storage system.

Preferably, the process also comprises a step of using said portions for preparing meals.

Preferably, said step of preparing dishes is performed by processing one or more of said predosed quantities (portions) using a multifunction unit configured for performing mixing, chopping and/or induction cooking functions.

Preferably, the process may also comprise a step of implementing at least one further operating step for thermal treatment of products or semi-finished products. For example, the further thermal treatment operating step may be performed in the same multifunction unit and/or in a different multifunction unit and/or in an ohmic heating device and/or in a refrigerator.

Preferably, the process may also comprise a step of implementing at least one further auxiliary step, for example washing.

Preferably, the process may also comprise a step of implementing at least one step of transforming semi-finished food products. The step of processing semi-finished food products may comprise, for example, pressing and/or grinding cereals and/or seeds to obtain flour and/or oil, respectively.

Preferably, said operating steps are performed by respective operating units operating by electricity.

Preferably, at least some of the operating steps are actuated by monitoring by an electronic control unit.

Preferably, the control unit is configured to receive information relating to operating parameters of said operating steps.

Preferably, the operating parameters comprise at least one energy absorption parameter of said operating steps.

Preferably, the electronic control unit provides an indication of exceeding a limit value of electrical power absorbed by said operating steps.

Alternatively or in addition, the electronic control unit may limit the overall energy absorption of said operating steps, in particular by means of a predetermined algorithm set to enable some of said operating steps and to disable other operating steps.

According to an embodiment, the step of preparing the dishes is performed by selecting one or more dishes from a menu as a function of the plants collected and stored in the distribution unit. Preferably, the step of collecting the plants is performed as a function of the degree of maturing of the plants.

According to a different embodiment, the step of preparing the dishes is actuated on the basis of a predetermined menu, in particular weekly. Preferably, in this case, the step of collecting the plants is performed as a function of the menu.

Preferably, the step of preparing the dishes is performed automatically or semi-automatically.

Preferably, the step of preparing the dishes is performed by supervision by an electronic control unit.

Preferably, the electronic control unit is accessible to a user by means of an input interface, for example a touch-screen interface and/or an augmented reality environment.

Preferably, the step of preparing the dishes comprises a plurality of sub-steps using a plurality of operating units.

Preferably, the operating units are connected to the electronic control unit to send to the electronic control unit information relating to operating parameters of the operating units and/or to receive commands from the electronic control unit.

Preferably, the electronic control unit is pre-configured to contain a plurality of pre-stored or pre-set menus.

Preferably, the pre-stored or pre-set menus can be selected by an operator and/or selected automatically by the electronic control unit as a function of at least one selection parameter.

Preferably, the selection parameter is a preset personal diet and/or information relating to ingredients available.

Preferably, each menu comprises a sequence of automatic operations which can be performed by the operating units and which can be activated automatically and/or manually.

Alternatively or in addition, each menu may comprise a sequence of operations to be performed manually by a user.

Further features and advantages of the invention are more apparent in the non-limiting description which follows of a non-exclusive embodiment of a kitchen system according to this invention.

### BRIEF DESCRIPTION OF THE DRAWINGS

The description is set out below with reference to the accompanying drawings which are provided solely for purposes of illustration without restricting the scope of the invention and in which:

FIG. 1 is a plan view of a kitchen system according to the invention;

FIG. 2 is a front view of the kitchen system of FIG. 1;

FIGS. 3 and 4 are two perspective views of respective parts of the kitchen system of FIG. 1 from two different angles;

FIG. 5 shows a component of the kitchen system of FIG. 1;

FIG. 6 shows a further component of the kitchen system of FIG. 1;

FIG. 6A is a top view of the component of FIG. 6;

FIG. 7 shows a further component of the kitchen system of FIG. 1;

FIGS. 8-10 show three different components used in an operating unit of the kitchen system of FIG. 1;

FIGS. 11-15 show an operating unit for the kitchen system of FIG. 1 formed by the components of FIGS. 8-10 and according to a succession of operating steps in sequence.

### DETAILED DESCRIPTION OF PREFERRED EMBODIMENTS OF THE INVENTION

With reference to the accompanying drawings, the numeral 1 denotes in its entirety a kitchen system according to the invention.

The kitchen system 1 is optimised to operate with a reduced energy impact, in particular configured for installation in a remote and harsh or extra-terrestrial environment and in particular in the absence of terrestrial ground and/or on spatial platforms. The term “harsh environment” means an environment with difficult access to the natural resources such as, for example, places close to glaciers or the North or South Poles or offshore platforms.

The kitchen system 1 according to the invention comprises a standing area 2 with a rectangular shape around which a working area 3 extends. The working area 3 comprises a raised work surface 4 positioned at a standard height, for example between 80 and 120 cm. The plan view of the work surface is C-shaped, defined by a central zone and two lateral zones.

The kitchen system 1 also comprises, positioned in the working area 3, operating units powered by electricity, in particular which can be used for operations directly connected with the preparation of food and auxiliary units. In particular, said operating units are designed for the thermal treatment of products or semi-processed products and designed for auxiliary operations, for example washing as well as designed for processing semi-processed food products.

According to the specific embodiment illustrated, the operating units used are the following:
a distribution unit 10, intended for the controlled distribution of ingredients or semi-finished products;
a multifunction unit 20, configured to carry out operations on ingredients or semi-finished products;
pasta making devices 30, configured for automatically preparing pasta or filled pasta and defining a pasta making unit;
a plurality of ohmic heating devices 40 operating for heating on containers, in particular closed thermoses, containing a semi-finished product or a product to be heated and/or sterilized, the ohmic heating devices defining an ohmic heating unit;
a plurality of pressing units 50 each configured for pressing or grinding raw materials;
two dishwashers 60;
a refrigerator 70.

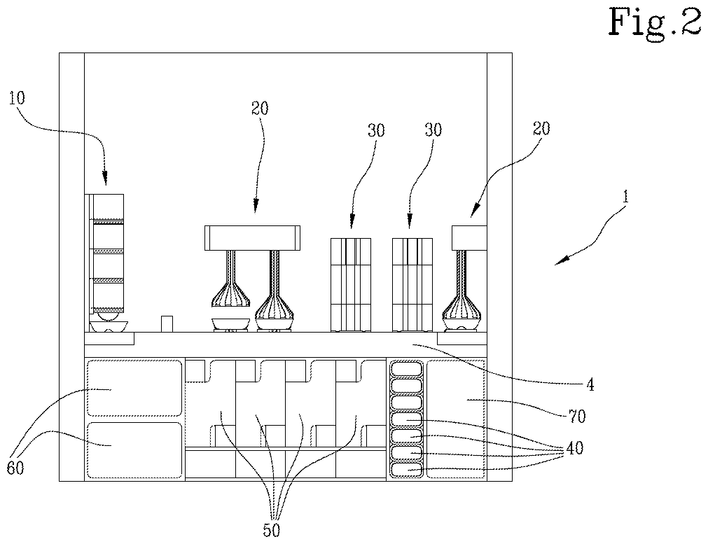

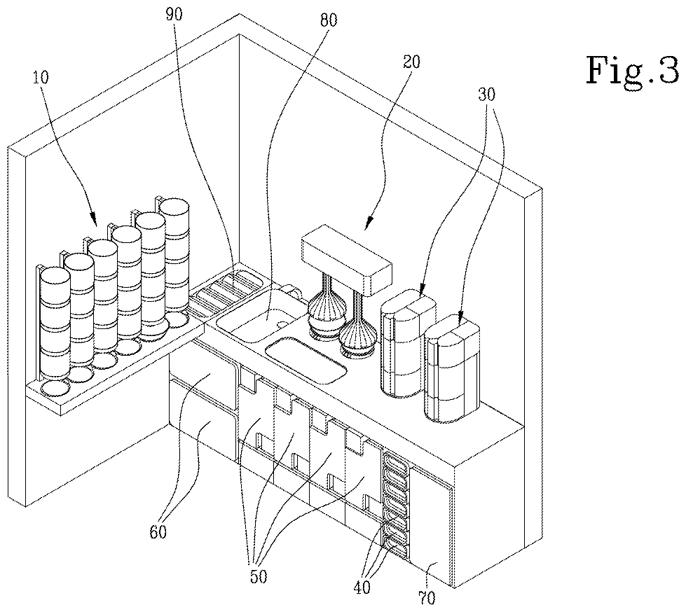

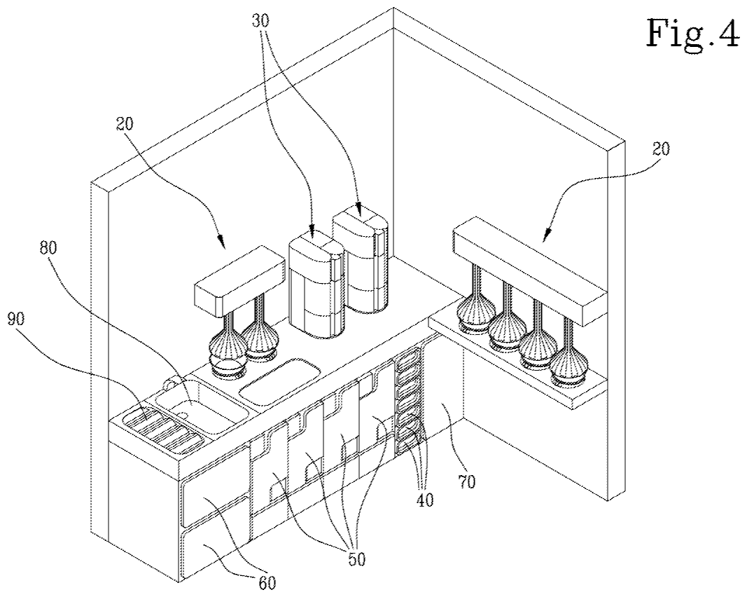

As shown in FIGS. 2 to 4, the distribution unit 10, the multifunction unit 20 and the pasta making devices 30 are positioned on the work surface 4.

Below the work surface 4, and in particular confined only in the central part, there are the dishwashers 60, the pressing units 50, the ohmic heating devices 40 and the chiller 70.

The kitchen system 1 also comprises a sink 80 positioned at the level of the work surface 4.

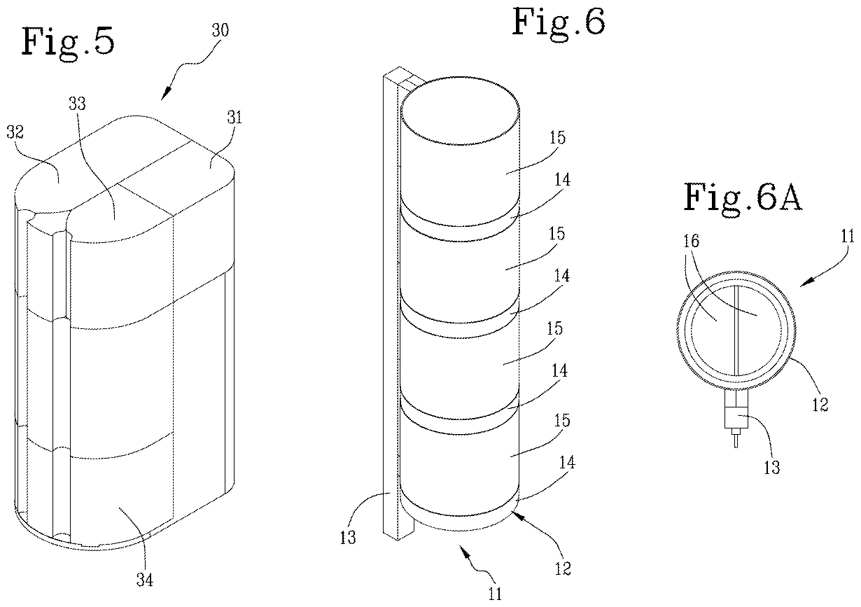

FIG. 5 shows one of the pasta making devices 30.

Each pasta making device 30 comprises a box-shaped body preferably made at least partly of transparent material, for example plastic. The pasta making device 30 also comprises upper openings 31, 32, 33 for receiving flour, water and filling, respectively, and a compartment or lower door 34 for dispensing one or more portions of pasta. The pasta making device 30 has fully automatic operation except for the loading of the ingredients and, if necessary, manual activation.

With reference to the distribution unit 10, it comprises a plurality of modules 11 each of which configured in the form of a column and illustrated in FIG. 6. The module 11 comprises a tubular body 12, made at least partly of material preferably transparent and in particular plastic, forming inside a duct extending vertically. The tubular body 12 is supported at the rear by an upright 13.

The tubular body 12 preferably comprises a plurality of superposed sections, each section comprising a supporting portion 14 and a containing portion 15, or compartment. The compartment 15 is designed to contain a predosed quantity of a product or raw material or semi-finished product, whilst the supporting portion 14 defines the lower support for the contents of the compartment 15. For this purpose, the supporting portion 14 has internally at least one wall which can be opened (shown in FIG. 6A), made preferably in the form of two complementary half-walls 16. The half-walls 16 are rotatable about respective horizontal axes of rotation, positioned preferably in an outer position, in such a way that the half-walls 16 can adopt an open position in which they are rotated downwards, in particular with a substantially vertical orientation, allowing the sliding of the contents in the compartment 15 below.

Each supporting portion 14 is associated with independent release means, with a manual or automatic action, for the controlled release of the contents of the respective compartment 15.

Preferably, each supporting portion 14 is associated with a respective weighing scales, in particular of the load cell type. The weighing scale is preferably associated with the respective wall which can be opened.

Below each module 11 there is a space, between the module 11 and the work surface 4, for supporting a collection container.

Therefore, by opening a wall which can be opened, the contents of a compartment 15 are discharged into the compartment below, or into the collection container in the case of the lower compartment.

The column structure makes it possible to sequentially release the contents in the collection container, starting from the lower compartment, rising each time to the one above, leaving open the walls which can be opened below.

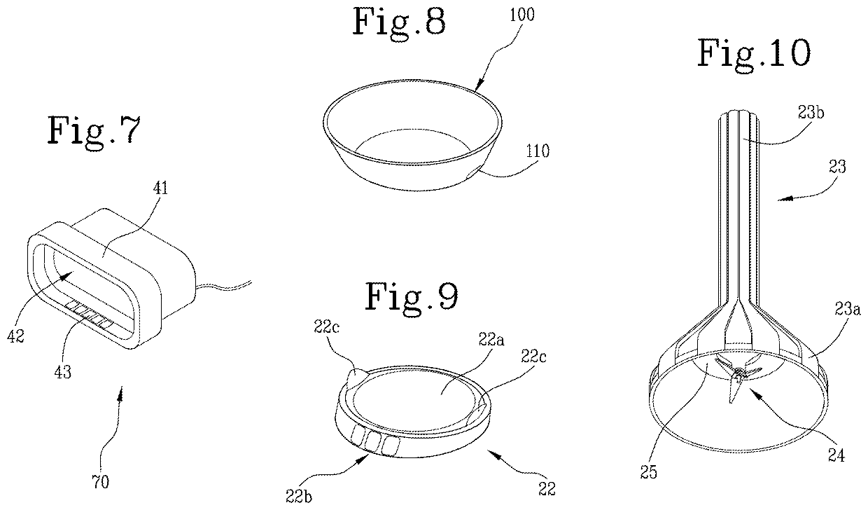

FIG. 7 shows an ohmic heating device 40 installed in the kitchen system 1. The ohmic heating device 40 comprises a receiving body 41 equipped with a front opening 42 for inserting a respective container (not illustrated) to be heated. By means of electrical contacts 43 (only some of which are shown in FIG. 7) positioned inside the receiving body 41 and configured to come into contact with the container during insertion, an automatic heating of the container can be obtained which can be activated directly by inserting the container in the front opening 42.

With reference to the multifunction unit 20, it comprises a plurality of identical operating stations 21, distributed on the work surface 4 and one of which is illustrated in detail in FIGS. 8-15.

The operating station 21 comprises a lower plate 22 (FIG. 9) for induction heating, in particular mounted on the work surface 4, and an upper hood 23 (FIG. 10) positioned above the plate 22.

The plate 22, preferably stably fixed to the work surface 4, has an upper supporting surface 22a for a container 100 (shown in FIG. 8) for induction heating, as well as electrical connections (not illustrated) and a control panel 22b comprising one or more switching on and/or adjusting buttons.

Preferably, the plate 22 may have one or more contact protrusions 22c engageable in corresponding recesses 110 of the container 100 to define a unique and stable positioning of the container 100 on the plate 22. It can be thought, on the other hand, that the protrusions and the recesses are made, respectively, on the container 100 and on the plate 22.

FIG. 10 shows a detail of the hood 23. The hood 23 is located above the corresponding plate 22 and is preferably movable vertically towards and away from the plate 22.

More in detail, the hood 23 comprises a lower portion 23a with larger width, configured to completely surround the periphery of a container 100 positioned on the plate 22 (FIG. 14). Preferably, the hood 23 also comprises an upper tubular portion 23b for moving away the cooking fumes.

The lower portion 23a contains internally mixing and/or chopping means 24 positioned and configured to operate inside a container 100 positioned on the plate 22.

The mixing and/or chopping means 24 comprise a rotary element equipped with blades, positioned inside the hood and facing downwards.

Preferably, the rotary unit can be lifted and lowered with respect to the hood 23, therefore independently of the hood 23, to adopt a position below protruding from the hood 23 (FIG. 14) in such a way as to be inserted in the container 100, and a position completely retracted in the hood 23 (FIGS. 12-13 and 15) to allow a safe operation by an operator in the positioning or removal of the container 100.

Preferably, the lower portion 23a also includes a heating counter-plate 25 configured to face the container 100 positioned on the plate 22 (in the operating configuration of FIG. 14), for example for cooking food with a flat shape which can be heated on both sides (flat breads or the like). The upper counter-plate 25 is preferably fixed with respect to the hood.

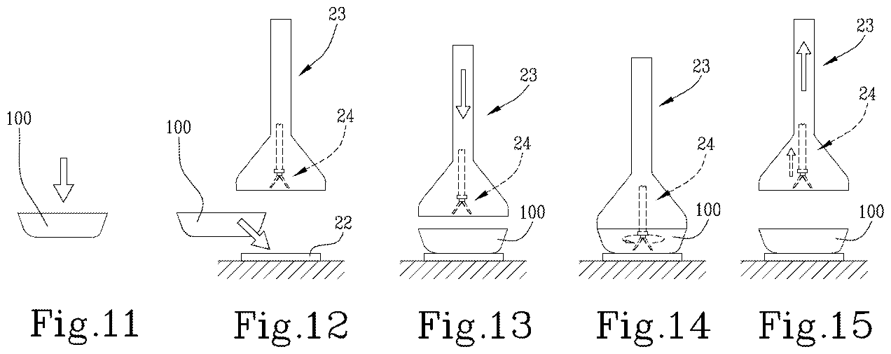

Therefore, as shown in FIGS. 11-15, once the container 100 has been positioned on the plate 22, the hood 23 is lowered (manually or automatically by means of respective actuators) to the operating position (FIG. 14) to actuate an operating step on the contents of the container 100. Subsequently, the hood 23 is raised and the container 100 is moved away.

Preferably, at least some of the above-mentioned operating units are configured in a modular fashion in such a way as to be able to add or remove modules, obtaining a desired number of modules. For example, the operating stations 21 of the multifunction unit 20 are distributed on the work surface in one or more groups, in such a way as to allow several dishes to be operated on simultaneously or to obtain a sufficient degree of redundancy, increasing the reliability of the system. Moreover, the ohmic heating devices 40 and/or the pressing unit 50 may be configured as a succession of adjacent modules, in particular integrated in a single compartment and individually accessible and/or operable.

With reference to the dishwashers 60, according to the embodiment illustrated there are two superposed and independent units, in such a way as to achieve a sufficient redundancy as well as a saving of water, in the case of a low number of items to be washed.

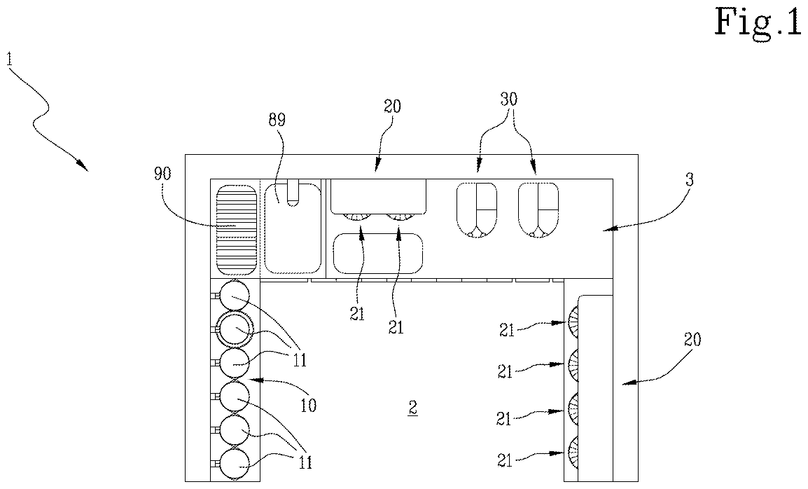

The kitchen system 1 also comprises an area for the growing of plants (not illustrated), in particular fruit and/or vegetables, operating in the absence of soil, in particular a hydroponic, aquaponic and/or aeroponic cultivation. The growing area is outside the environment of FIG. 1, therefore outside the working area 3, but preferably positioned in the immediate vicinity for reasons of logistics simplification which will be described below.

Preferably, the operating units 10-70 are configured to operate automatically, in particular in a fully automatic manner, apart from an activation controlled by the user. In particular, this automatic operation may occur by automatically activating the operating unit following the supply of the necessary ingredients (for example, in the pasta making device 30 or in the pressing unit 50).

The kitchen system 1 also comprises an electronic control unit (not illustrated) connected to the operating units 10-70 (to all or at least some of them) for receiving information relating to operating parameters of the operating units 10-70. Preferably, the electronic control unit is connected to the operating units 10-70 to receive information relating to at least one energy absorption parameter from the operating units 10-70 (more specifically, an instantaneous absorbed power parameter).

The electronic control unit may also be configured to determine and/or set up operating conditions of the operating units 10-70. This may be achieved by allowing the electronic control unit to directly activate or control the operating units 10-70, preferably in order to enable or disable the operation of each 10-70 unit. In effect, in this solution, the electronic control unit may intervene to prevent exceeding the total power absorption, keeping it below a predetermined threshold and preferably selecting which operating unit to enable and which to disable.

For example, the electronic control unit may be configured to provide an indication of exceeding a limit value of absorbed electrical power, preferably an audio and/or luminous signal, indicating to the user that the activation of an operating unit can lead to or is leading to the exceeding of the power threshold, thus signalling the need to stop the operating unit (or in any case intervene manually to return the absorption within the allowed range). In the latter circumstance, the electronic control unit may be configured to simulate the energy absorption level planned for an operating cycle of the operating units and to prevent activation of one or more operating units depending on the overall energy absorption level planned. In other words, the electronic control unit may have information regarding the sequence of activation of the operating units 10-70 of a predetermined cycle to be actuated and therefore be aware of a sufficiently precise estimate of the power absorption of that cycle.

According to a different embodiment, the electronic control unit intervenes directly by disabling one or more operating units. For example, the electronic control unit may include a predetermined algorithm set to enable the operation of some operating units and to disable the operation of the other operating units whilst maintaining the overall power absorption below the predetermined threshold.

In any case, the electronic control unit can intervene directly (operating on the operating units) or indirectly (monitoring the operating units) on the operating units, preventing the predetermined power threshold from being exceeded.

The electronic control unit is also connected to the area for growing plants for collecting information regarding the progress of the growth of the plants. Preferably, this information is obtained by analysing images collected by one or more video cameras, in particular using an automatic system based on artificial intelligence. In this way, the electronic control unit may have information on the need to collect the plants closest to maturing and can generate a signal, in particular visual and more preferably displayable on a screen of a tablet, smartphone or touch-screen control panel, to inform a user of the need to implement this collection.

Preferably, the electronic control unit is configured to provide instructions to the user regarding the methods of storage of the plants in the compartments 15 of the distribution unit 10 after collection.

For example, the electronic control unit may operate in an augmented-reality environment to indicate to the user the compartments 15 suitable for receiving each type of plant collected. For this purpose, the electronic control unit may generate visual information superposed on the view of the operating units and/or of the kitchen system 1 and visible by an operator by means of a suitable screen, facilitating the operations for the operating units by the operator (in particular, at least of the distribution unit 10).

Preferably, the storage of the plants in the distribution unit 10 is performed in such a way that each column module 11 contains only a same type of plant.

Preferably, the supporting portions 14 of the distribution unit 10 have outside a portion or strip of light which can be activated by the electronic control unit to signal to the user a compartment 15 to be filled (or a compartment 15 from which to pick up a plant to be used).

The electronic control unit may comprise a plurality of pre-stored menus (stored by the manufacturer or by a user) or pre-set menus (that is to say, pre-selected from a list of menus) and which can be selected by an operator and/or selected automatically as a function of at least one selection parameter. The menu may be implemented for preparing a specific dish.

Preferably, the selection parameter may be a preset personalised diet which can be defined, for example, as a function of one or more characteristics of the individual user, in particular age, weight, gender, nutritional needs, medical history.

The selection parameter may also be information relating to ingredients available, in particular the ingredients stored in the distribution unit.

Each menu therefore comprises a sequence of automatic operations which can be performed by the operating units and which can be activated automatically and/or manually to prepare the dish. In that case, the user only takes care of positioning the container 100 in the treatment zones and the possible manual addition of ingredients.

Each menu may also comprise a sequence of operations to be performed manually by a user. In this case, the operator acts manually following a sequence of instructions provided visually (touch-screen or augmented-reality) or in audio mode from the electronic control unit

Preferably, the electronic control unit is also connected or connectable to sensors worn by a group of kitchen users (for example, a work team) for collecting personal health data of the users. These health data can be used to monitor the health status of the users and to present this information on request or to establish a diet suitable for the current state of health identified on the basis of the data received.

According to a process for using the kitchen system according to the invention, a step is implemented for growing plants, in particular fruit and/or vegetables, in the absence of terrestrial ground, preferably a hydroponic, aquaponic and/or aeroponic cultivation.

The plants obtained from this cultivation are collected (on the basis of criteria established for example by means of the electronic control unit as a function of the maturing level of the plants themselves) and stored in the form of predosed quantities in the distribution unit, in particular filling the compartments or containers 14 of the same column module 11 with plants of the same type. In that way, each column 11 of the distribution unit 10 can dispense a respective type of plant.

Because of the type of cultivation, the washing of the plants is not necessary.

Preferably, however, the plants may be subjected to removal of reject parts (leaves, twigs or other) before being positioned in the distribution unit 10, in particular by means of a receiving opening 90 communicating with a collection container. In that case, the waste parts are preserved and used as fertiliser for hydroponic, aquaponic, and/or aeroponic cultivation.

Moreover, the electronic control unit stores information on the contents of each compartment or container, in particular being assigned to the electronic control unit the generation of instructions on the filling of each compartment or container 14 (using audio/video information, preferably by augmented-reality or use of luminous indicators on the distribution unit).

Following an instruction by the electronic control unit, in particular as a function of a selected menu to be made, the user picks up one or more predosed quantities of plants from respective compartments or containers 14 of the distribution unit 10, dispensing them directly in a container 100 positioned below the respective column. In particular, a manual or automatic activation is performed of the compartment or container 14 positioned lower down in the column 11 and not empty.

The user can add further ingredients, for example stored in a storage unit (for example, oil obtained by pressing seeds in the pressing unit 50).

When the ingredients necessary for preparing the dish are reached, the user places the container 100 at an operating station 21 of the multifunction unit 20 where the ingredients are subjected to at least one operation between cooking, mixing and chopping.

In the case of cooking, the fumes produced are collected and filtered.

If necessary, the preparation obtained in this way or an excess part may be introduced into a closed container or thermos and sterilized by one of the ohmic heating devices 40 to be stored and used at a different time.

Preferably, at least some of the operating steps performed by the above-mentioned operating units 10-70 are performed by supervision by an electronic control unit, which receives information relating to operating parameters of the operating steps and therefore of the operating units 10-70.

An operating parameter comprises an energy absorption parameter of each operating unit 10-70.

Moreover, the electronic control unit provides an indication of exceeding a limit value of electrical power absorbed by the operating units 10-70 and is configured to intervene when the instantaneous power absorbed value exceeds the limit value or when the instantaneous power consumption prediction exceeds that threshold. In effect, the electronic control unit may contain information regarding the programmed sequence for activating the operating units, for example according to a predetermined menu; a dynamic behaviour of the kitchen system 1 can therefore be simulated, obtaining a forecast of the trend over time of the instantaneous power absorption.

In particular, the electronic control unit may limit the overall energy absorption of the operating units by enabling some of said operating steps and for disabling other operating steps.

Preferably, the electronic control unit is pre-configured to contain a plurality of pre-stored or pre-set menus, where in particular some ingredients and/or some preparation steps can be fixed and others can be modified by an operator.

Preferably, the pre-stored or pre-set menus can be selected by an operator and/or selected automatically by the electronic control unit as a function of at least one selection parameter.

The selection parameter can be a pre-set personal diet. In this case, the step of preparing the dishes is performed on the basis of a predetermined menu, in particular a weekly or twice-weekly menu. Preferably, in this case, the step of collecting the plants is performed as a function of the menu.

The selection parameter may also be information relating to ingredients available.

In this case, the step of collecting the plants is performed as a function of the degree of maturing of the plants and the step of preparing the dishes is actuated by selecting one or more dishes from a menu as a function of the plants collected and stored inside the distribution unit.

The kitchen system described above and the relative kitchen process solve the technical problem which forms the basis of the invention, in particular thanks to a high level of volumetric compactness and a reduced degree of energy absorption, suitable under remote and harsh conditions where the availability of space and/or energy are critical.

Moreover, the kitchen system according to the invention is suitable for installation in environments where it is not possible to have terrestrial ground and therefore support a traditional cultivation.

The kitchen system according to the invention is also extremely compact (for example, according to the embodiment illustrated in FIGS. 1 to 4, the overall size of the working area is approximately 1.70 m3) and, despite this, has a high degree of redundancy such as to overcome various faults whilst maintaining a sufficient functionality. In effect, several operating units consist of a plurality of identical modules.

Lastly, it should be considered that the kitchen system according to the invention allows users to be guided in the preparation of the dishes in conditions of optimised spaces and times.

This makes the kitchen system usable even in environments which are not strictly remote and harsh but where it is necessary to guide the user in following operations which are optimised in terms of spaces and functionality.

1. A low energy impact kitchen system, configured for installation in a remote and harsh or extra-terrestrial environment and in particular in the absence of terrestrial ground and/or on space platforms, comprising a standing area for a user, a working area positioned around the standing area and, positioned in the working area, operating units powered by electricity, said operating units comprising at least:
a distribution unit, comprising a plurality of containers or compartments and configured to store and release individually in a controlled manner a plurality of predetermined doses of different raw or semi-processed materials;
a multifunction unit configured for actuating functions of mixing, chopping and/or cooking by induction a raw or semi-processed material or a mixture of raw or semi-processed materials;
further operating units designed for the thermal treatment of products or semi-processed products and/or designed for auxiliary operations, for example washing, and/or designed for processing semi-processed food products;
wherein said kitchen system also comprises an area for the growing of plants, in particular fruit and/or vegetables, operating in the absence of soil, in particular a hydroponic, aquaponic, aeroponic cultivation.

2. The kitchen system according to claim 1, wherein said distribution unit comprises a plurality of columns placed side by side and extending at least partly vertically and each having a plurality of containers or compartments positioned in a stacked configuration, each column having release means, either manually or automatically, for releasing a single dose, in particular adjacent containers or compartments being separated from each other by a wall which can be opened in a controlled manner for discharging a dose into the underlying container or compartment and the lower containers or compartments being provided with a wall which can be opened in a controlled manner, said release means acting on said wall which can be opened to determine an opening of the wall which can be opened.

3. The kitchen system according to claim 1, wherein the multifunction unit comprises one or more operating stations each equipped with a lower plate for induction heating and an upper hood which can be lifted and lowered and equipped with mixing and/or chopping means to operate in a container positioned between the lower plate and the upper hood; preferably, said operating stations being aligned along a direction of extension of the working area around the standing area.

4. The kitchen system according to claim 1, wherein said operating units also comprise a pasta making device positioned in the working area and configured for the automatic preparation of pasta or filled pasta, said pasta making device comprising upper openings for receiving flour, water and filling and a lower compartment or hatch for dispensing one or more portions of pasta.

5. The kitchen system according to claim 1, also comprising at least one ohmic heating device actuated on containers, in particular closed thermoses, containing a semi-finished product or a product to be heated and/or sterilized; said at least one ohmic heating device being positioned in the working area and comprising a receiving seat equipped with a front opening for inserting a respective container to be subjected to heating.

6. The kitchen system according to claim 1, also comprising at least one pressing unit positioned in the working area and configured for pressing cereals and seeds and obtaining, respectively, flour and oil.

7. The kitchen system according to claim 1, wherein said operating units are configured to operate automatically, preferably in a fully automatic manner apart from an activation controlled by the user.

8. The kitchen system according to claim 1, also comprising an electronic control unit connected to the operating units for receiving information relative to operating parameters of said operating units and for determining and/or setting up operating conditions of said operating units, preferably said electronic control unit being operable by a user using an input terminal of the touch screen type, in particular a smartphone, a tablet or a control panel.

9. The kitchen system according to claim 8, wherein said electronic control unit is connected to said operating units to receive information relating to at least one energy absorption parameter and is configured to provide an indication of exceeding an absorbed electrical power limit value and/or to limit the overall energy absorption of said operating units, in particular by means of a predetermined algorithm set for enabling the operation of some of said operating units and to disable the operation of the other operating units.

10. The kitchen system according to claim 8, wherein said electronic control unit is also connected to said area for growing plants for collecting information regarding the progress of the growth of said plants.

11. The kitchen system according to claim 1, wherein the working area comprises a work surface on which are positioned said distribution units and multifunction units and having in plan view a configuration which is preferably C or L-shaped.

12. The kitchen system according to claim 11, wherein the ohmic heating device and/or said pressing unit are positioned below the work surface and are made in a modular fashion by means of a plurality of modules placed side by side.

13. A cooking process in a remote and harsh or extra-terrestrial environment and in particular in the absence of terrestrial ground and/or on spatial platforms, comprising the following steps:
implementing a cultivation of plants, in particular fruit and/or vegetables, operating in the absence of soil, in particular a hydroponic, aquaponic, aeroponic cultivation;
collecting said plants and storing them in a distribution unit preconfigured to separately house predetermined portions of said plants and to individually release in a controlled manner said predetermined portions of plants;
picking up individual portions of said plants from the distribution unit and using said portions to prepare dishes using a multifunction unit configured to actuate functions of mixing, grinding and/or cooking by induction.

14. The process according to claim 13, wherein said step of preparing the dishes is performed by selecting one or more dishes from a menu as a function of the plants collected and stored in the distribution unit, said step of collecting the plants being preferably performed according to the degree of maturing of the plants.

15. The process according to claim 13, wherein said step of preparing the dishes is carried out on the basis of a predetermined menu, in particular weekly, said step of collecting the plants being preferably performed as a function of the menu.

16. The process according to claim 13, wherein said step of preparing the dishes is performed, preferably automatically or semi-automatically, by monitoring by an electronic control unit accessible to a user and containing a plurality of pre-stored or pre-set menus, said step of preparing the dishes comprising a plurality of sub-steps performed by a plurality of operating units connected to said electronic control unit for sending from the electronic control unit information relative to operating parameters of the operating units and/or for receiving commands from the electronic control unit.

17. The process according to claim 13, also comprising a step of pressing seeds and/or grinding cereals in a pressing unit to obtain, respectively, oil and/or flour, and a subsequent step of storing said oil and/or flour.

18. The process according to claim 13, wherein said distribution unit comprises a plurality of columns positioned side by side and extending at least partly vertically and each forming a plurality of compartments or containers positioned in stacked configuration, each column having release means, either manually or automatically, for releasing a single dose, in particular, vertically adjacent compartments or containers being separated from each other by a wall which can be opened in a controlled manner for discharging a dose into the underlying compartment or container and the lower compartments or containers being equipped with a wall which can be opened in a controlled manner, wherein said release means act on said walls which can be opened and wherein said step of picking up individual portions of plants is performed by operating manually or automatically at least one of said walls which can be opened.
